(19) United States
(12) Patent Application Publication
(10) Pub. No.: US 2015/0064982 A1
(43) Pub. Date: Mar. 5, 2015

(54) EXPANSION CARD CONNECTOR FOR COMPUTER CHASSIS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YI-FANG WU, New Taipei (TW); KE CHEN, Shenzhen (CN); FOO SEE WOEI, Shenzhen (CN)

(21) Appl. No.: 14/469,897

(22) Filed: Aug. 27, 2014

(30) Foreign Application Priority Data
Aug. 29, 2013 (CN) 2013103839019

(51) Int. Cl. H01R 13/506

(52) U.S. Cl. CPC H01R 13/506
USPC 439/686

(57) ABSTRACT

Expansion card connector includes a main body and a protecting member. The main body includes a mounting frame. The mounting frame includes a retaining portion and a securing portion. A sliding passage is defined in the retaining portion. The protecting member includes a sliding portion and a mounting portion. The sliding portion is slidably received in the sliding passage, and the securing portion is engaged with the mounting portion for preventing the sliding portion from disengaging from the sliding passage.

### FIELD

The present disclosure relates to connectors, and particularly to a connector for positioning an expansion card in a computer chassis.

### BACKGROUND

Connectors are used to electronically connect a first object to a second object. The connector includes a contact, a terminal, an interface, and other conductors. For example, a first connector is connected to a second connector via a cable, and the second connector is connected to a circuit board to electronically couple the first connector with the circuit board. The cables of the connectors maybe exposed out of the connectors.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a expansion card connector in accordance with an embodiment.

FIG. 2 is similar to FIG. 1, but viewed from a different angle.

FIG. 3 is assembled view of the expansion card connector of FIG. 1.

FIG. 4 is similar to FIG. 3, but viewed from a different angle.

### DETAILED DESCRIPTION

The disclosure is illustrated by way of example and not by way of limitation in the figures of the accompanying drawings in which like reference numerals indicate similar elements. It should be noted that references to “an” or “one” embodiment in this disclosure are not necessarily to the same embodiment, and such references mean “at least one.”

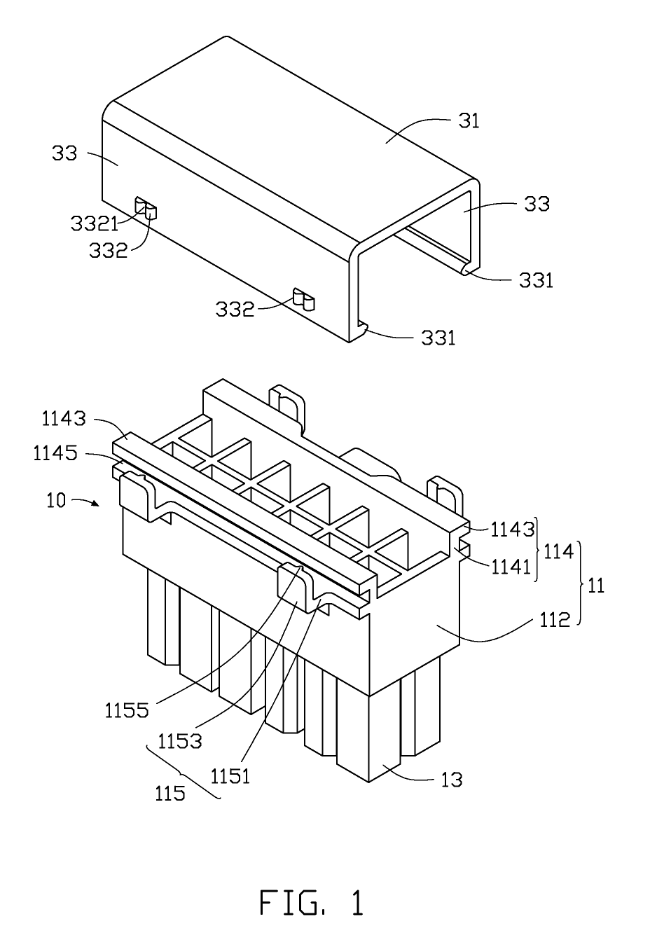

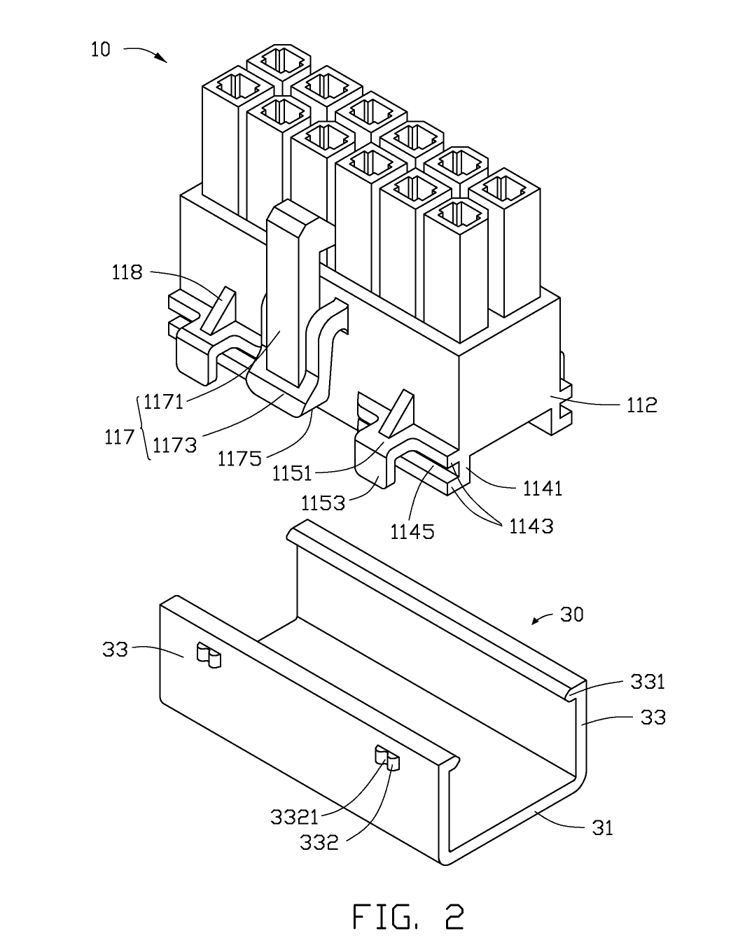

FIGS. 1-3 illustrate an expansion card connector in accordance with an embodiment. The expansion card connector comprises a main body 10 and a protecting member 30 slidably attached to the main body 10.

The main body 10 can comprise a mounting frame 11 and a plurality of plugs 13 connected to the mounting frame 11. The mounting frame 11 comprises a frame base 112 and two sliding portions 114 located on opposite sides of the frame base 112. The frame base 112 is substantially rectangular. Each retaining portion 114 comprises a connecting panel 1141 and two side panels 1143 extending from opposite edges of the connecting panel 1141. In at least one embodiment, the two side panels 1143 are substantially parallel to each other. The connecting panel 1141 and the two side panels 1143 cooperatively define a sliding passage 1145. In at least one embodiment, an extending direction is substantially parallel to the connecting panel 1141. Two securing portions 115 extend from one of the two side panels 1143 of each retaining portion 114. Each securing portion 115 comprises a coupling piece 1151 and a securing piece 1153 connected to the coupling piece 1151. In at least one embodiment, the coupling piece 1151 is substantially perpendicular to the securing piece 1153 and the side panel 1143. A securing tab 1155 is located on the securing piece 1153. A strengthening tab 118 is connected to the coupling piece 1151 and the frame base 112 for strengthening the strengthening securing portion 115. In at least one embodiment, the strengthening tab 118 is substantially triangular.

A limiting portion 117 is located on the frame base 112 and attached to one of the two side panels 1143. The limiting portion 117 comprises a connecting portion 1171 and an abutting portion 1173 connected to the connecting portion 1171. The abutting portion 1173 comprises a flat surface 1175.

The protecting member 30 comprises a top plate 31 and two side plates 33 extending from opposite edges of the top plate 31. Each side plate 33 comprises an engaging portion 331 corresponding to the sliding passage 1145. Two mounting portions 332 are located on an outer surface of each side plate 33. Each mounting portion 332 defines a mounting slot 3321 corresponding to the securing tab 1155.

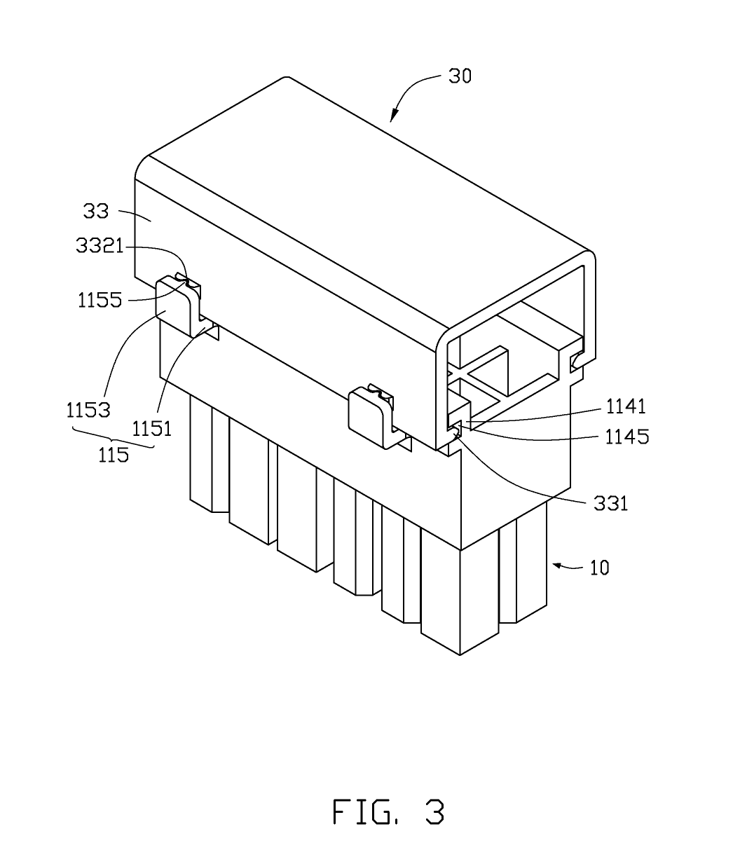

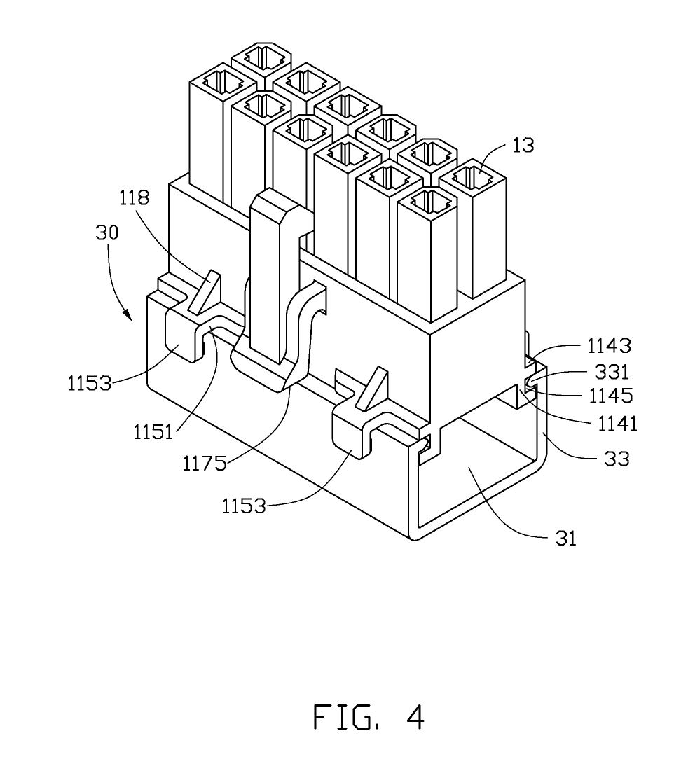

FIGS. 3-4 illustrate assembly of the expansion card connector of an embodiment. The protecting member 30 is located on a first side of the main body 10, and the two sliding portions 331 are aligned with the two corresponding sliding passages 1145.

The protecting member 30 is moved in a first direction that is substantially parallel to connecting panel 1141, so that each sliding portion 331 is slid in each sliding passage 1145. Simultaneously, the securing portions 115 are deformable away from the side plate 33. When the securing tabs 1155 are aligned with the mounting slots 3321, the securing portions 115 are released to engage the securing tabs 1155 in the corresponding mounting slots 3321 to prevent the protecting member 30 from moving in a second direction that is opposite to the first direction. At this time, the abutting portion 117 abuts the side plate 33.

In disassembly, the securing portions 115 are deformable away from the side plate 33 to disengage the securing tabs 1155 from the corresponding mounting slots 3321. The protecting member 30 is moved in the second direction, so that each sliding portion 331 is slid in each sliding passage 1145. Thus, the protecting member 30 can be removed from the main body 10.

It is to be understood that, even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure. The described embodiments are illustrative, and should not be construed as limiting the following claims.

What is claimed is:

1. An expansion card connector comprising:
a main body comprising a mounting frame; the mounting frame comprising a retaining portion and a securing portion; a sliding passage defined in the retaining portion;
a protecting member comprising a sliding portion and a mounting portion;
wherein the sliding portion is slidably received in the sliding passage, and the securing portion is engaged with the mounting portion, thereby preventing the sliding portion from disengaging from the sliding passage.

2. The expansion card connector of claim 1, wherein the retaining portion comprises a connecting panel and two side panels connected to the connecting panel, the sliding passage is defined by the connecting panel and the two side panels.

3. The expansion card connector of claim 2, wherein the securing portion extends from one of the two side panels.

4. The expansion card connector of claim 2, wherein the securing portion comprises a coupling piece and a securing piece connected to the coupling piece, and a securing tab is located on the securing piece to engage with the mounting portion.

5. The expansion card connector of claim 4, wherein the securing piece is substantially perpendicular to the coupling piece.

6. The expansion card connector of claim 4, wherein a strengthening tab is connected to the mounting frame and the coupling piece, and the strengthening tab is substantially a triangle.

7. The expansion card connector of claim 1, wherein the protecting member comprises a top plate and a side plate connected to the top plate, and the sliding portion extends inwardly from the side plate.

8. The expansion card connector of claim 7, wherein the mounting portion extends from an outer surface of the side plate, a mounting slot is defined in the mounting portion, and the securing portion is engaged in the mounting slot.

9. An expansion card connector comprising:
a main body comprising a mounting frame and a plurality of plugs connected to the mounting frame; the mounting frame comprising a securing portion;
a protecting member; a mounting portion located on the protecting member;
wherein the protecting member is slidably attached to the mounting frame, and the securing portion is engaged with the mounting portion for preventing the protecting member from disengaging from the mounting frame.

10. The expansion card connector of claim 9, wherein the mounting frame further comprises a retaining portion, a sliding passage is defined in the retaining portion, and the protecting member comprises a sliding portion slidably received in the sliding passage.

11. The expansion card connector of claim 10, wherein the retaining portion comprises a connecting panel and two side panels connected to the connecting panel, the sliding passage is defined by the connecting panel and the two side panels.

12. The expansion card connector of claim 11, wherein the securing portion extends from one of the two side panels.

13. The expansion card connector of claim 11, wherein the securing portion comprises a coupling piece and a securing piece connected to the coupling piece, and a securing tab is located on the securing piece to engage with the mounting portion.

14. The expansion card connector of claim 13, wherein the securing piece is substantially perpendicular to the coupling piece.

15. The expansion card connector of claim 13, wherein a strengthening tab is connected to the mounting frame and the coupling piece, and the strengthening tab is substantially a triangle.

16. The expansion card connector of claim 9, wherein the protecting member comprises a top plate and a side plate connected to the top plate, and the sliding portion extends inwardly from the side plate.

17. The expansion card connector of claim 16, wherein the mounting portion extends from an outer surface of the side plate, a mounting slot is defined in the mounting portion, and the securing portion is engaged in the mounting slot.
